(19) United States
(12) Patent Application Publication
(10) Pub. No.: US 2013/0304834 A1
(43) Pub. Date: Nov. 14, 2013

(54) METHODS AND SYSTEMS FOR ACCOMPLISHING BUSINESS APPLICATION PROCESSES THROUGH A MESSAGING SERVICE

(71) Applicant: INFOSYS LIMITED, Bangalore (IN)

(72) Inventors: Patrick Jayaseelan, Bangalore (IN); Manish Srivastava, Bangalore (IN)

(73) Assignee: Infosys Limited, Bangalore (IN)

(21) Appl. No.: 13/890,840

(22) Filed: May 9, 2013

(30) Foreign Application Priority Data
May 9, 2012 (IN) 1818/CHE/2012

(51) Int. Cl. H04L 29/08

(52) U.S. Cl. CPC H04L 67/32
USPC 709/206; 709/217

(57) ABSTRACT

Systems and methods for accomplishing a business application process of a business application through a standard messaging platform are disclosed. A user sends a request message having a subject field through a standard messaging platform. If the subject field includes at least one command pattern corresponding to a predetermined action for the business application, command action logic corresponding to the at least one command pattern is invoked. Information and potential user actions resulting from the business service function are identified and returned to the user in a response message. In response to the user taking action on the response message, an action message having a subject line corresponding to the action taken by the user on the response message is generated.

### RELATED APPLICATION DATA

This application claims priority to Indian Patent Application No. 1818/CHE/2012, filed May 9, 2012, which is hereby incorporated by reference in its entirety.

### BACKGROUND

Enterprise business applications have become essential in today's work environment. For example, business applications for accounting, asset tracking, logistics, human resources, and the like are well known. Business applications, of course, provide a user interface (UI) through which users can access the application for data entry, report generation and other activities, collectively known as “business processes”. Recently, in view of the demand for remote access and efficient IT management, many business applications provide web based applications and mobile applications that can be accessed through a standard web browser or other dedicated application to accomplish business processes.

Known business applications leverage messaging platforms, such as email platforms for alerting users and directing users to the application. An email form can be sent to a user notifying the user of specific workflows that need attention with links to entry points into the application for addressing the workflow. For example, an email might be sent to a user informing the user that an expense form requires approval. The email may have a hyperlink to the business application entry point, which launch as the business application, for approving expense forms. Alternatively, the email might direct the user to forward the email to various addresses based on the desired action. One email address might be the “approval” address and another email address might be the “disapproval” address. Data is then incorporated into the business application based on which address is used for forwarding.

Also, it is known to provide product specific email interfaces, such as Outlook forms and surveys, that are suitable for data collection. U.S. Pat. No. 7,774,408 discloses the use of an email system for providing an interface to business applications. Emails with predefined entry fields are used to retrieve data. Existing methods rely on product specific capabilities, such as Microsoft Outlook and Exchange Server. Known methods of leveraging messaging platforms for a user interface of business applications require predefined forms, links, workflows, or other elements and thus do not provide the user with flexible, on demand interaction with the business application.

### BRIEF DESCRIPTION OF THE DRAWINGS

FIG. 1 is a functional block diagram of a computer architecture of the disclosed embodiment.

FIG. 2 is flowchart of a business process flow of an embodiment.

FIG. 3 is an example of a request message.

FIG. 4 is an example of a response message.

While systems and methods are described herein by way of example and embodiments, those skilled in the art recognize that the systems and methods are not limited to the embodiments or drawings described. It should be understood that the drawings and description are not intended to be limiting to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION

Disclosed embodiments provide computer-implemented methods and systems for providing a message-driven user interface for business applications that facilitates accomplishing business processes.

The embodiments provide on-demand, command driven interaction between business applications and a user's messaging interface, such as an email interface. Messages are sent with command links which enable action from any messaging client program running on any type of user device, without the need to launch the business application. By adopting markup language format emails, the embodiments do not rely on product specific methods. Business services provide markup language structured to a message generator component. Therefore, messaging capability is de-linked from core business logic. Any information in business applications along with related action commands can be exposed in business services and delivered via a standard messaging interface.

The embodiments include a mechanism to translate a business activity into an email command link, and a mechanism to deliver business information on-request by email. Combining three core elements, business service applications command links and a messaging service allows the messaging service, such as email to be used as an interaction channel to business system activities allowing a message, such as an email message, to trigger business activities.

A messaging command model enables on-demand access to business systems, which otherwise require intranet/internet enabled applications, without the need for dependency on hyperlinks to open the business application. Further messaging capability is externalized from core business logic, and does not restrict business application interaction to specific workflow sequences.

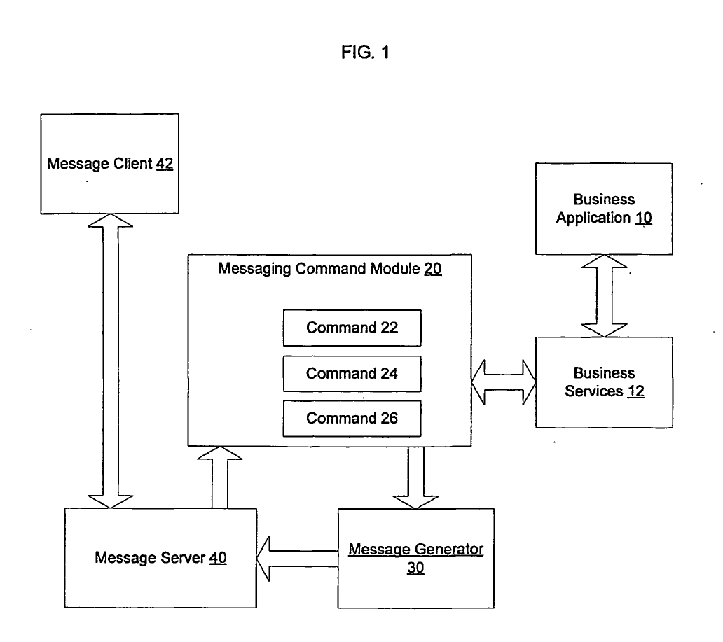

FIG. 1 illustrates a computer architecture of a disclosed embodiment. Business application 10 is a known business application, such as an accounting application, running on a computing device. Business services 12 can be in the form of web services and exposes identified business application functionalities through a service interface. The service interface emits and accepts structured information, such as information in XML format, when respective functionality is invoked by message command module 20 (discussed below). Business services module 12 also includes logic to validate data input received from messaging command module 20. Further, business services 12 connects to a backend business logic layer and/or database of business application 10.

Messaging command module 20 is the bridge between business applications 20 and the messaging platform, such as an email platform. Messaging command module 20 monitors specified email accounts (i.e., addresses), parses/matches email content (subject, body), and invokes the appropriate business service function. Messaging command module 20 can be a collection of command processors, such as commands 22, 24 and 26 that handle different action commands as described below.

Message generator 30 converts business services returned information in a structured format, such as XML, into user friendly text. Message generator 30 parses the data elements, and translates the data into well formed content in accordance with a schema or the like. Message generator 30 also can handle additional content needs, such as graphics, application icons, resized images, and the like, and creates response messages with action links and the appropriate subject line for sending to the message client 42, through message server 40.

Message server 40 and message client 42 constitute the messaging platform and can be an email server/client or other messaging platform such as instant messaging. As an example, messaging server 40 can be a Microsoft Exchange Server. Messaging server 40 can include a web services interface to manage the specified accounts. Messaging client 42 can include a browser or other HTML capability to support rich content and email action links.

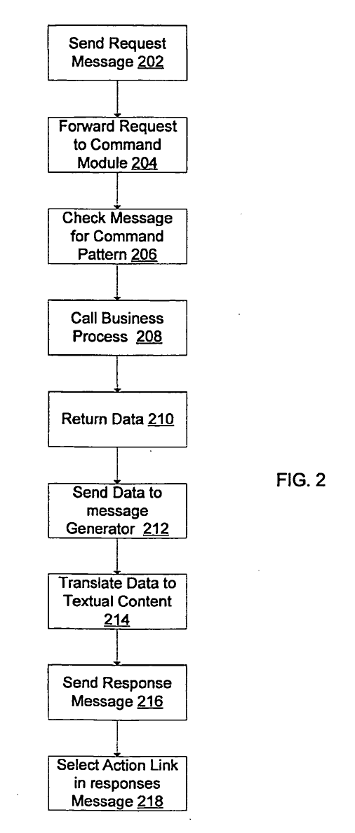

FIG. 2 illustrates a business process flow. In step 202, a user of messaging client 42 sends a request message, an email message in this example, to a specified email account of message server 40. In step 204, the email is forwarded to messaging command module 20 if the address in the email corresponds to a business process action. In step 206, message command module 20 checks the subject line for known command patterns by correlating the subject to commands 22, 24, 26 of FIG. 1. Of course, there can be any number of commands, only three of which are illustrated for clarity. In step 208, messaging command module 20 invokes respective command action logic for any matching subjects. When no matching command pattern is found, default action logic can be invoked. In the command logic, message elements, such as username, email body, subject line, attachments, and reference data from subject line, can be identified.

In step 208, the command logic calls a business process function for the identified command, through business services 12, and passes any other identified information for processing. Business application 10 then completes the requisite processing using known backend application logic and database records. The command logic may invoke additional business service functions depending on identified data elements in the message.

In step 210, business application 10 returns data records and possible action commands on the data, that are to be sent to the user in accordance with the invoked business process. The command logic can aggregate returned information from multiple service calls. In step 212, the aggregated business information, such as information from data records in a database of business application 10, is sent to message generator 30 along with elements identified from the request message sent in step 202. In step 214, message generator 30 translates the information into textual content and translates action commands on the data into recognizable action links. The concept of action links is described in greater detail below. Message generator 30 can also call other business services to create rich information content, such as images, sound, video, and the like. As an example, if the returned information includes reference to specific persons, a picture of those persons can be accessed from a human resources database and included in the returned information.

In step 216, message generator 30 connects to message server 40, through a web service, for example, and sends a response message to the user of message client 42. The response message includes requested business information and action links that relate to actions that can be taken related to the information, such as confirm, approve, reject, initiate other processes, and the like. The actions correspond to actions supported by commands 22, 24, and 26 of FIG. 1.

In step 218, the user clicking on any action link in the response message, triggers the preparation of an action message with a pre-filled subject line, including the appropriate command pattern, reference data, and the like, corresponding to the requested action of the action link. On sending the email created in step 218, the user accomplishes the business process remotely. Of course, the process can iterate over several return messages and actions taken thereon.

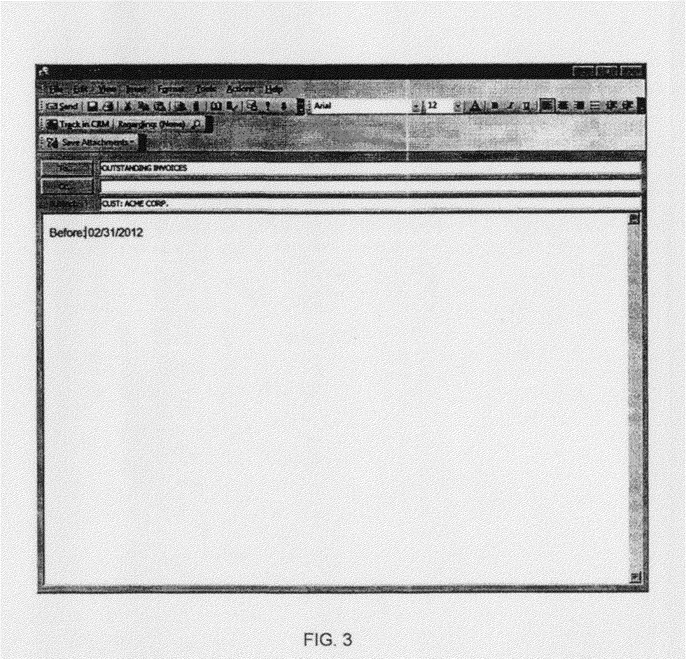

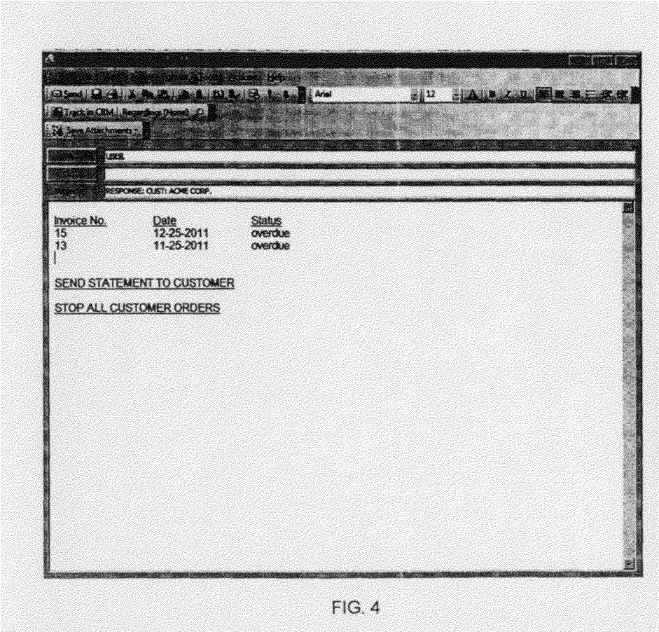

The command patterns in the subject of the message can cause any business process action to be accomplished. The action can be specified by the command pattern and the email address in combination. As an example, as shown in FIG. 3, an email can be used to query an accounting system, such as business application 20, for all outstanding bills for a specific customer. The request email can be addressed to OUTSTANDING INVOICES and can include the command pattern CUST: ACME CORP. in the subject line. The response email message will include information relating to all outstanding invoices for the customer ACME Corporation, as shown in FIG. 4. The response message may also include action links that allow the user to take related actions. For example, as shown in FIG. 4, action links in the response message can include SEND STATEMENT TO CUSTOMER, STOP ALL CUSTOMER ORDERS, or the like. If the user selected the SEND STATEMENT TO CUSTOMER action link, a process is initiated which causes a statement of outstanding invoices to be sent to the customer by the accounting system. Other parameters can be placed in the email message. For, example, the message body could include a critical date for the invoices or the like, as shown in FIG. 3.

Mail box addresses and command patterns are stored in messaging command module 20 along with any requisite syntax and/or grammar, as commands 22, 24, 26, as shown in FIG. 1. The command patterns are associated with specific actions through a database of command module 20, which can be a simple lookup table or a more complicated structured database. It can be seen that actions can include any business process actions or workflows, such as database entries or queries, content publication, workflow triggers or events, and the like. Of course all actions and associated addresses, subjects, parameters, syntax and grammar, can be published to users in order to inform users of the system capabilities. Any type of messaging platform can be used.

The various computing devices may be separate devices, may be integrated in a single device, or any combination of devices (e.g., a computing device operatively coupled to a touch-screen display device, a plurality of computing devices attached to a single display device and input device, etc.). The computing devices may be one or more servers, for example a farm of networked servers, a clustered server environment, or a cloud network of computing devices.

Embodiments have been disclosed herein. However, various modifications can be made without departing from the scope of the embodiments as defined by the appended claims and legal equivalents.

What is claimed is:

1. A computer implemented method for accomplishing a business application process of a business application through a standard messaging platform, said method comprising:
receiving a request message having a subject field through the standard messaging platform;
determining if the subject field includes at least one command pattern corresponding to a predetermined action for the business application;
invoking command action logic corresponding to the at least one command pattern to call a business service function;
identifying information and potential user actions resulting from the business service function;
translating the information and user action commands into textual information;
creating a response message from the textual information;
sending the response message to a user through the standard messaging platform; and
in response to the user taking action on the response message, receiving an action message from the user, the action message having a subject line corresponding to the action taken by the user on the response message.

2. The method of claim 1, wherein the standard messaging platform is an email platform and wherein the request message, the response message, and the action message are email messages.

3. The method of claim 1, further comprising passing processing information identified in the request message for processing by the business service function.

4. The method of claim 1, wherein said identifying step and said translating step are based on a schema.

5. The method of claim 1, wherein the request message is generated by the user.
